(19) United States
(12) Patent Application Publication
(10) Pub. No.: US 2002/0144933 A1
(43) Pub. Date: Oct. 10, 2002

(54) Scrap rubber processing system

(76) Inventor: Hans Detampel, Berlin (DE)

Correspondence Address: JENNER & BLOCK, ONE IBM PLAZA, CHICAGO, IL, 60611, US

(21) Appl. No.: 09/982,489

(22) Filed: Oct. 17, 2001

(30) Foreign Application Priority Data
Oct. 17, 2000 (DE) 100 53 013.3

(51) Int. Cl. B03B 1/00

(52) U.S. Cl. 209/3

(57) ABSTRACT

Plant for the processing of spent rubber and spent rubber products by cryogenic size reduction, comprising freeze tunnels for freezing the material stock to be reduced, foreign material separating means and reducing means for the deep-frozen material. To this end, a multi-stage pre-reducing system comprising reducers (17, 17a) is provided. The pre-reduced material stock is directed through a freeze system divided into a plurality of freeze zones in which a low-temperature liquid refrigerant may be sprayed onto the material stock. The freeze system has a temperature equalizing system connected to the output thereof, and the deep-frozen material stock is comminuted to a fine grain size in a step-wise fashion in subsequent multi-stage fine reducers.

### BACKGROUND OF THE INVENTION

1. Field of the Invention

The present invention relates to a system for processing scrap rubber and spent rubber products by multi-stage cryogenic size reduction, comprising freeze means for freezing the material to be reduced, foreign material separating means and screening means.

2. Description of the Related Art

Spent vehicle tires and industrial rubber product waste are a rich source of raw materials.

The steadily growing quantities of such scrap and waste constitute a considerable environmental burden. Given the principles of a recycling economy and the worldwide efforts undertaken to reduce CO₂ emissions, the recycling of spent vehicle tires and rubber product waste is gaining importance.

For example, patent document DE 39 15 984 C1 discloses a plant for the disposal, i.e. the recycling, of scrap rubber. A problem arises from the fact that rubber, being vulcanized caoutchouc, is not softened but charred by heating. The prior installation uses a freeze tunnel comprising two successive parts each having a conveyor moving the material from an input end to an output end, with the output end of the first conveyor being located above the input end of the second conveyor.

Another reducing plant is described in patent document DE 1004 460 B1. This plant uses a more or less random pre-cooling treatment. It is not possible with this plant to subject the material stock to a well-aimed refrigeration or freeze treatment. The high consumption and low efficiency of the refrigerant used present additional drawbacks.

Another source of scrap rubber is the great quantities of tire casings unfit for retreading. Vehicle tires of this kind raise a considerable disposal problem because of the high percentage of metal or fiber (textile) they contain. In conventional disposal by combustion, they generate major amounts of noxious gaseous emissions the disposal of which requires expensive filtering. The fiber or metal reinforcements incorporated in the casings cause additional problems.

The well-known cryogenic process is used to comminute scrap rubber to form a secondary raw material suited for reuse in production processes. To this end, the elastomeric scrap rubber is frozen to very low temperatures by means of a refrigerant such as—preferably—liquid nitrogen. The temperature should be approx. −140° C. to cause the scrap rubber to assume a brittle condition suitable for milling.

The prior processes are disadvantageous in that it is hardly possible to freeze and embrittle the spent tire stock down into the deep core regions thereof. This would require the to act on the spent tire stock for an extended period of time. At the same time, the slowly freezing tires must be transported in a manner which precludes re-heating by friction.

Another problem are the fiber or metal reinforcements and inserts incorporated in the tire casings. These components too are valuable raw materials too; the recovery thereofin as pure a form as possible is highly desirable.

Recycling processes such as the pyrolysis process described in document WO 9908849 cannot satisfy this demand as all organic components of the scrap rubber are decomposed into their petrochemical constituents, with major portions of the pyrolysis products consumed for generating the energy the process as such needs.

A number of plants have been developed for the production of rubber granulate and rubber powder. They are characterized in that theypre-reduce spent tires using well-known technology and then freeze and comminute the scrap rubber.

Further, document DE 40 33 599 C2 discloses a plant comprising freeze tunnels arranged in two parallel process lines. The freeze tunnels include pumping means for directing the refrigerant from one to the other part for temperature equalization. The tunnels also include means for circulating the refrigerant undergoing evaporation. These measures result in the scrap rubber stock being subjected to the refrigerant for a sufficient period of time and with sufficient intensity.

The systems described above use a one-step freeze reduction and comminution of the scrap rubber stock. It has turned out, however, that the rubber granulates and rubber powders that can be produced in such cryogenic reducing plants have properties which make them unfit for industrial-scale reprocessing and recycling. They include major portions of foreign materials such as fiber and/or steel; their consistencies vary substantially and the granule size spectrum is coarse. Scrap rubber products of this nature are unfit for industrial-scale reuse in the production of vehicle tires; moreover, they raise considerable processing problems. Besides, the reinforcements such as fiber or metal are not cleanly separated from each other and include excessive amounts of rubber residues.

It is the object of the present invention to provide a plant enabling scrap rubber and rubber waste products to be recycled as completely as possible and—using the freeze process known per se—to be converted into a secondary raw material suited for production processes.

The aforesaid object is attained by the measures recited in patent claim 1, and especially by multi-stage pre-reduction means, a subsequent multi-stage freeze plant comprising a pre-freeze tunnel system adapted to have used cold refrigerant gas additionally injected therein, a main freeze tunnel system in which a liquid refrigerant may be sprayed on the pre-reduced input material, and a temperature equalizing system, and by further means following the freeze system, namely, multi-stage reducing means for frozen material, screening and separating processes for processing the material, another subsequent freeze plant consisting of a pre-freeze tunnel system adapted to have cold used refrigerant injected thereinto, and a main freeze tunnel system in which a liquid freeze refrigerant may be sprayed on the pre-reduced material, as well as a temperature equalizing system, and finally by one or more comminuting means for frozen material following the freeze system, as well as subsequent classifying and separating means for processing the powder so produced to have the desired condition.

These measures allow rubber granulates and rubber powder to be produced which have a very high degree of purity. Such rubber granulates and rubber powders are easily incorporated in new vehicle tires and other rubber products without adversely affecting the strength, the load-bearing capacity or other technical properties thereof. This allows the consumption of fresh raw materials to be reduced, resources to be used more sparingly and the problems arising from the disposal of spent tires to be solved in an effective manner.

To this end, the elastomeric scrap rubber is cooled down to very low temperatures with the aid of a deep-freeze refrigerant, preferably liquid nitrogen. The processing temperature should be lower than approx. −70° C. to −90° C. so as to cause the scrap rubber to become brittle and to enable it to be reduced to a granular condition in such a manner that, in the process, the rubber material will be released from the reinforcing steel wire and fiber inserts. A problem is that the freeze treatment and the embrittlement should penetrate the used tires into to the deep core zones thereof, which requires the refrigerant to act on the spent tires for a sufficient period of time.

The overall process is divided into two main processes, namely, a cryogenic granulation process and a cryogenic rubber powder production or comminution process, which are combined with reducing, screening and sorting techniques specially matched to this application. The tires are pre-reduced in several stages and passed through freeze tunnels divided into several freeze zones in which a liquid deep-freeze refrigerant is sprayed on the material to be treated. Following the freeze process, the frozen material is reduced and cleaned in subsequent multi-stage processes involving the separation of metal and fiber constituents. The high-purity granulate so produced is input to another freeze process, reduced in specialized comminuting apparatus to form a finely particulate powder, and are then cleared of foreign materials.

In its entirety, the overall granulation and pulverizing process is arranged in a manner such as to enable repairs and maintenance to be performed quickly and easily. To this end, stationary relocating means are provided to enable the various reducing and separating units to be moved each from the operating position to a servicing position with a small number of manual operations. Hoisting equipment (not shown) installed above the freeze tunnels facilitate any repair work that may have to be carried out in the servicing position.

Additional advantageous measures are described in the dependent claims. The invention is illustrated in the attached drawings and described in greater detail below.

### BRIEF DESCRIPTION OF THE DRAWINGS

FIG. 1 shows a schematic view of a tire reduction plant comprising multi-stage pre-reduction, subsequent separation and coarse-particle return, metal/fiber separation and metering means;

FIG. 2 shows a schematic view of a freeze installation comprising two parallel freeze tunnels having different temperature zones, refrigerant spray means and a subsequent equalizing tunnel;

FIG. 3 schematically shows a multi-stage reducing arrangement including separating and classifying means following the freeze tunnels;

FIG. 4 schematically shows granulate heating means;

FIG. 5 schematically shows classifying and reducing means;

FIG. 6 schematically shows multi-stage granulate classifying means;

FIG. 7 schematically shows granulate post-cleaning, packaging and loading means;

FIG. 8 schematically shows granulate pre-cooling, freezing and pulverizing means including cold gas return means;

FIG. 9 schematically shows rubber powder heating apparatus; and

FIG. 10 schematically shows a powder classifying system.

### DETAILED DESCRIPTION OF THE INVENTION

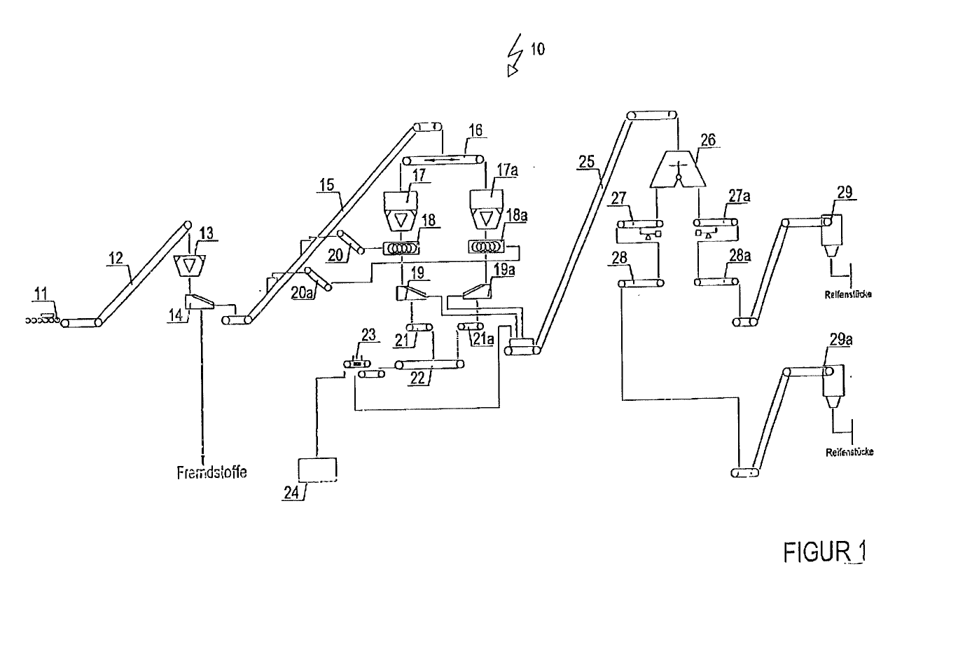

The tire reducing system 10 shown in FIG. 1 consists substantially of a tire infeed assembly 11 including metering means 11a and feed means 12. Tire infeed assembly 11 has connected to the output thereof a first reducer 13 which pre-reduces the spent tire stock fed in to some specific particle size. Following reducer 13 is a separator 14 adapted to separate mineral components and water.

A conveyor 15 moves the coarsely reduced infeed stock via distributing means 16 to second reducers 17 and 17a. Distributor 16 is reversible so as to enable the parallel reducers 17, 17a to be loaded in a uniform manner.

Alternatively, conveyor 15 may be loaded with pre-reduced infeed material stock consisting of spent tires or plastic-metal-fiber composites.

Reducers 17, 17a are followed by grading means 18 and 18a feeding separators 19 and 19a, which separate exposed steel and fiber reinforcements and fines. Retained stock is transported by conveyor system 25 to a distributor 26. Exposed reinforcements and fines are combined by combiners 21 and transported via break-up means 22 to a steel separator 23.

Steel separator 23 is used to separate from the fines the exposed reinforcements obtained so far, especially metal components. Metal components of this kind—especially bead wire fragments from truck tires—may be 5 to 10 cm long and 2 to 6 sq.mm. in cross sectional area. The output from steel separator 23 is directed to an assembly system such as a depositing container assembly (not shown in detail) for recycling the separated steel fragments for subsequent use.

The rubber fragments cleaned in steel separator 23 are merged with the main stock stream arriving from separators 19 and 19a. Conveyor 25 transports the main stock stream along two parallel lines for uniform distribution by distributor means 26-29a.

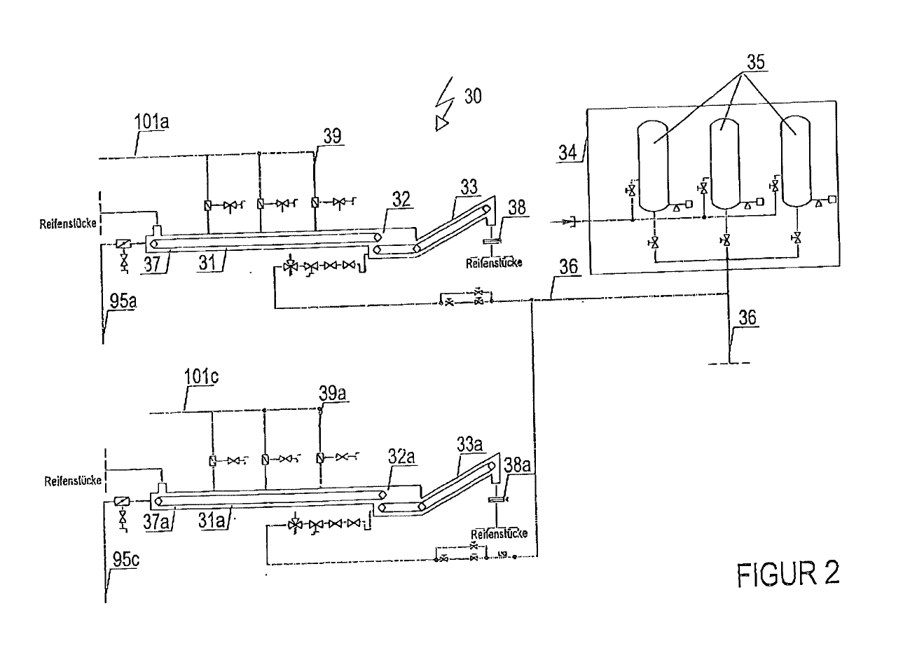

Distributor 26 and metering means 27 and 27a associated therewith divide the stream of tire fragments to be reduced among parallel loading conveyors 28 and 28a in a uniform manner. Loading conveyors 28, 28a transport the tire fragments via a feed-in system 29 and 29a to a freeze installation shown in detail in FIG. 2.

In order to obtain a high availability of the overall plant, the freeze system 30 illustrated in FIG. 2 is made up of equipment and units arranged in parallel. In this system, the rubber fragments—such as tire chunks—are frozen to a temperature below their brittle point. For rubber, the brittle point is in the range of about −80° C. to −120° C.

Freeze system 30 must ensure that the temperature of the product stream does not rise above that point in subsequent reduction processes which involve an infeed of energy. As a matter of experience, a stock temperature of approx. −110° C. to −150° C. (corresponding to 163-123 K) should be maintained for granulation and pulverization.

Freeze system 30 serves to freeze the tire fragments by means of a refrigerant. In order to maintain a sufficient refrigerant supply, freeze system 30 has associated therewith a refrigerant supply system 34 holding the refrigerant—preferably liquid nitrogen—in refrigerant tanks 35. The refrigerant is directed from refrigerant tanks 35 through specialized refrigerant supply lines 36 to main freeze tunnel systems 32 and 32a.

Freeze system 30 itself consists of two substantially horizontal freeze tunnels associated each with a pre-freeze tunnel system 31 and 31a and a main freeze tunnel system 32 and 32a. Provided between these two systems are equalizing systems 33 and 33a for temperature equalization.

The freeze stock is supplied by load systems 29 and 29a to special conveyors 37 and 37a of pre-freeze tunnel systems 31, 31 a to be transported thereby through the various freeze zones. Load systems 29, 29a are designed to prevent an uncontrolled escape of refrigerant gas and its cooling energy to the environment.

Conveyors 37,37a are driven by variable-speed drives providing for infinite adjustment and optimization of the stock dwell time within the freeze tunnels. Thermally induced length changes of conveyors 37, 37a are compensated by a spring mount assembly.

Pre-freeze tunnel systems 31,31 a include a plurality—preferably two to five—cold gas infeed ports 39 and 39a for supplying used refrigerant gas at freeze temperatures from a downstream granulate freeze system 93 to be described below. A closed-loop control scheme (not described in detail) is used to maintain the desired temperature of the used refrigerant gas—preferably gaseous nitrogen—which is directed into the pre-freeze zones.

In main freeze tunnel systems 32, 32a, the refrigerant is sprayed on the pre-reduced tire chunks, where it will evaporate. As a result, the efficiency of utilization of the cold energy of the gaseous nitrogen is very high and the stock temperature is reduced in a step-wise fashion.

The intensive freeze treatment of the tire chunks is assisted by gas circulating and transport fans. The multiple high gas flows in the tunnel region produce a turbulent flow at Re>3000, so that the heat transfer performance is enhanced decisively.

The gaseous nitrogen at deep-freeze temperatures is directed against the product stream of main freeze tunnel systems 32, 32a into pre-freeze tunnel systems 31, 31a. With its temperature increasing, the gaseous nitrogen reaches a gas outlet port on load system 29, 29a and is directed in cold gas tubing lines 95a and 95c to granulate freeze system 93 for pulverization.

The well-aimed spraying-in of the refrigerant and the controlled gas transport scheme obviate a slanted position of the pre-freeze and main freeze tunnel systems 31, 31a and 32, 32a.

There is no need to provide a nitrogen immersion bath any longer; neither need the cold sink to the bottom. This advantageously and in a cost-saving manner reduces the space required to set up the freeze tunnels.

Main freeze tunnel systems 32, 32a are followed by relatively short temperature equalizing systems 33, 33a disposed in an inclined position. These zones are used for equalizing the temperatures in the tire chunks.

Freeze System 30 is designed in modular form and consists completely of corrosion-resistant materials, preferably high-grade steel. The thermal insulation—provided to have a very high quality—is designed to keep the temperature from dropping below the dew point. The modules are approx. 3 m to 4 m long and may be combined to set up freeze systems of any length. The tunnels of the pre-freeze tunnel systems 31, 31a and those of main freeze tunnel systems 32, 32a are designed to be easily accessible to repair and maintenance personnel. To this end, they include stationary floor-mounted portions (not shown) that allow the upper tunnel portions to be raised vertically by means of hydraulic jacks for inspection and cleaning.

Along the sides, high-grade steel feet are secured to lateral frame struts by threaded fasteners extending through the floor-mounted portion. They are adjustable for compensating uneven portions in the mounting surface. The hydraulic jacks (not shown) are connected to specialized lifting feet threadingly fastened to the lateral frame struts within the floor-mounted portion.

An electronic control unit is provided to control and regulate the spraying-in of the refrigerant gas, the speed of the special conveyor system 37, 37a and the gas flows within pre-freeze tunnel systems 31, 31a, main freeze tunnel systems 32, 32a and temperature equalizing systems 33, 33a in an optimum manner as required by the product input and ambient temperatures. Depending on requirements, the control system may be set up to implement various temperature regimes in the pre- and main freeze systems and in equalizing systems 31-33a.

To this end, the freeze tunnels are equipped as necessary with instruments, fittings, meters, controls and indicators, all of these set up in an operator-friendly manner in a control cabinet.

If the stock flow is interrupted, the control units reduces the refrigerant gas infeed while maintaining the operating temperature in the main freeze tunnel system 32 or 32a. In the event of lengthy standstills, the control unit maintains the temperature at some specific level so as to compensate the temperature difference on restart.

Thereafter, when production is resumed, the stock that initially leaves temperature equalizing system 33 or 33a will have the desired temperature.

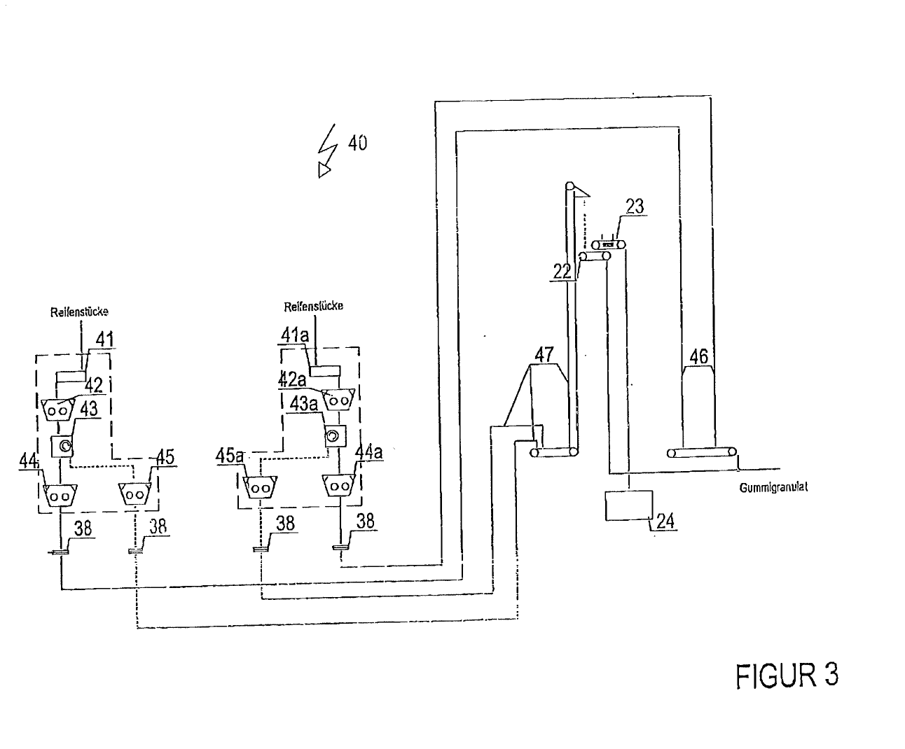

Freeze system 30 is followed by the granulation system 40 shown in FIG. 3. The deep-frozen, very brittle stock is uniformly fed by loading means 41, 41a into the granulation system. A two-stage process is used for granulation 40. In the first stage, specialized reducing rollers 42 and 42a effect coarse reduction wherein the various tire components—such as rubber, fiber and steel—are separated as far as possible.

The subsequent separators 43 and 43a separate steel and rubber-steel composites from the stock stream and supply them to another cryogenic separator 45 or 45a, which disintegrates remaining steel-rubber composites and at the same time reduces the amount of rubber remaining. The rubber-fiber/steel mixture so generated is supplied by conveyor system 47 to break-up means 22. Separator 23 removes any steel components and transports them to a collection site or assembly means. Now free of steel, the rubber-fiber mix is returned to the main stock stream in conveyor system 46.

The main stock stream leaving reducers 42 or 42a is fed to second reducers 44 or 44a in the form of a rubber-fiber mix. Reducers 44 and 44a are designed and conFIG.d to separate the rubber from fiber components as completely as possible. While the structure of the fiber components is maintained, the rubber portion is reduced to form a granulate having a relatively uniform particle size of 1 to 20 mm, preferably 1 to 8 mm.

Transport system 46 transports the rubber-fiber mix—together with the steel-free rubber-fiber mix from separator 23—to drying apparatus 49.

Reducers 42, 42a, 44 and 44a as well as cryogenic separators 45 and 45a are specialized machines designed, and using manufacturing materials suited, to withstand the particular nature of the loads and stresses occurring in very low temperature operation.

Reducers 42, 42a, 44 and 44a and cryogenic separators 45 and 45a have speed-regulated drives allowing the reduction process to be finely adjusted to the nature of the spent tires to be processed.

Reducers 42,42a,44,44a and the separators are temperature and sound insulated. The system in its entirety is encapsulated and operates without releasing dust.

Conveyor systems 46 and 47 are provided with shut-off means 38, 38a which prevent the escape of cold gas from the encapsulated systems during the removal of individual units thereof to their servicing position.

Conveyor systems 46 and 47 are completely insulated thermally and designed to keep as small as possible the amounts of cold gas allowed to reach downstream processes.

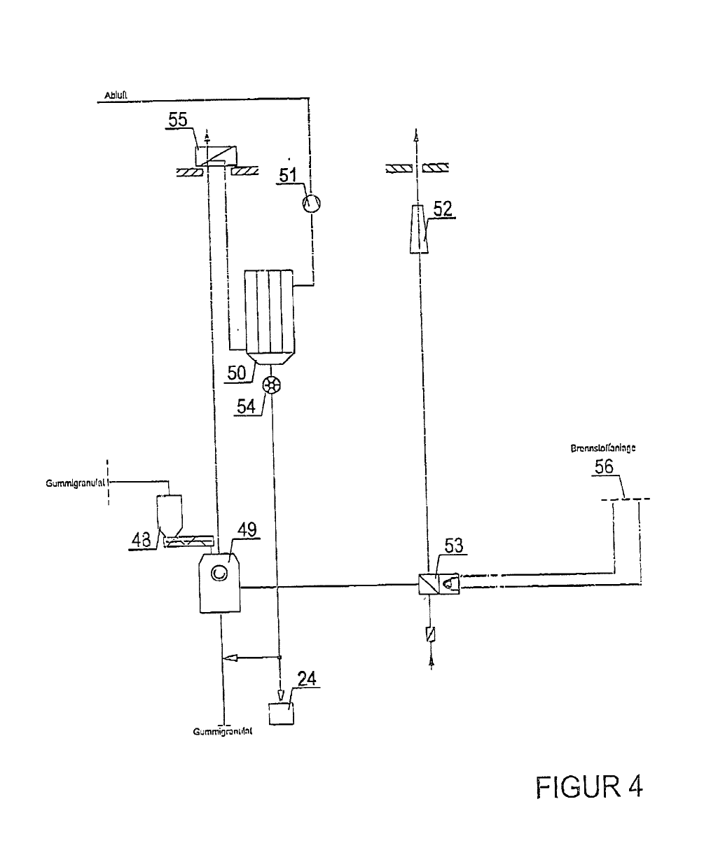

The low-temperature stock produced in granulation process 40 will absorb major amounts of moisture immediately on contact with the ambient air as the temperature at the granule surfaces drops below the dew point so that the moisture in the ambient air precipitates. In order to avoid or restore that precipitation of moisture, the granulate is transported by load means 48 into heating and drying means 49 of the kind shown in FIG. 4.

Heating and drying means 49 preferably comprises a drum-type drier as it enables a high throughput process to be run continuously. In combination with the rotary movement of the drum, the efficiency of the heat exchange between the drying air and the treated stock is enhanced by particular equipment measures.

The air is heated indirectly by means of a modulating heater 53 so as to safely and gently heat the treated stock and at the same time implement fire and explosion prevention measures.

Burner off-gases are released to the ambient air through an off-gas line system 52. Exhaust air from the heating process is directed into a dust separator 50 for cleaning through a tubing system including safety equipment 55.

The dust separator may have connected to the output thereof a fan 51 to ensure optimum air streams. Dust separator 50 includes all necessary safety devices and is designed to meet the requirements of fire and explosion protection.

The separated dust is discharged through discharge means 54 to assembly means 24 or returned to the main production stream. Heating and drying means 49 have associated therewith fuel supply means 56 preferably providing oil or gas.

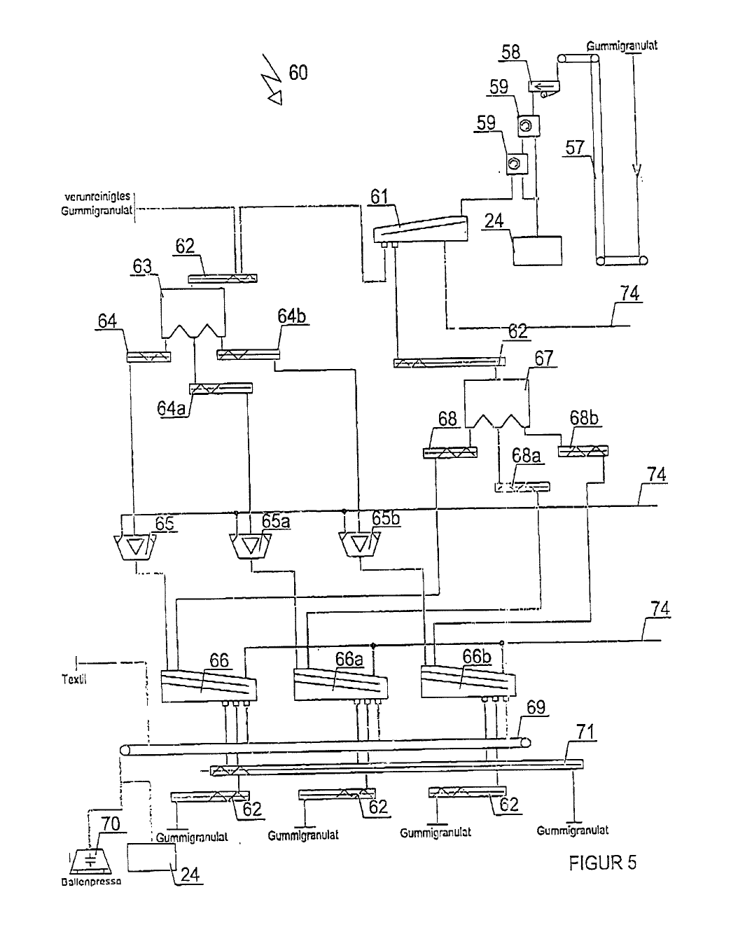

From the output of the heating and drying means 49 the granulate is fed via conveyor 57 and load means 58 to a variety of pre-cleaning systems as shown in FIG. 5.

The steel residues ultimately remaining are separated completely by a plurality of sequentially connected separators 59. The cleaned granulate is then fed to a pre-classifying system 60.

In the first pre-classifier 60, the stock is sorted to form various streams and directed to further processing. In second pre-classifier 61, oversized particles, fiber components and rubber-fiber composites are separated and fed to intermediate storage 63 by conveyor 62.

Metering means 64, 64a, 64b are operative to transport the stock from intermediate storage to post-processing means 65, 65a, 65b. In post-processing means 65, 65a, 65b, which are arranged in parallel, oversized granules are reduced and fiber components converted to a separable condition. The stock so processed is fed to the subsequent separation process.

The granulate formed during pre-classification is transported by conveyors 62 to intermediate storage 67 and then—together with post-processed stock—to parallel separating means 66, 66a, 66b by loaders 68, 68a, 68b.

The fiber components in the stock are processed, separated and cleaned in separators 66, 66a, 66b. The fiber material is fed to downstream fiber assembly system 70—preferably using baling presses—by fiber conveyors 69.

The aforesaid separators 66, 66a, 66b are operative also to separate undersized particles. Such undersized particles are conveyed by collecting and conveying means 71 to post-cleaning in powder processing systems to be described.

Separators 66, 66a, 66b are encapsulated in a dust-proofmanner and connected via aspiration ports to a central dust suction or aspiration system 74. A high degree of freedom from dust is ensured by specialized aspiration means in the machine and an integrated granulate pre-screening treatment.

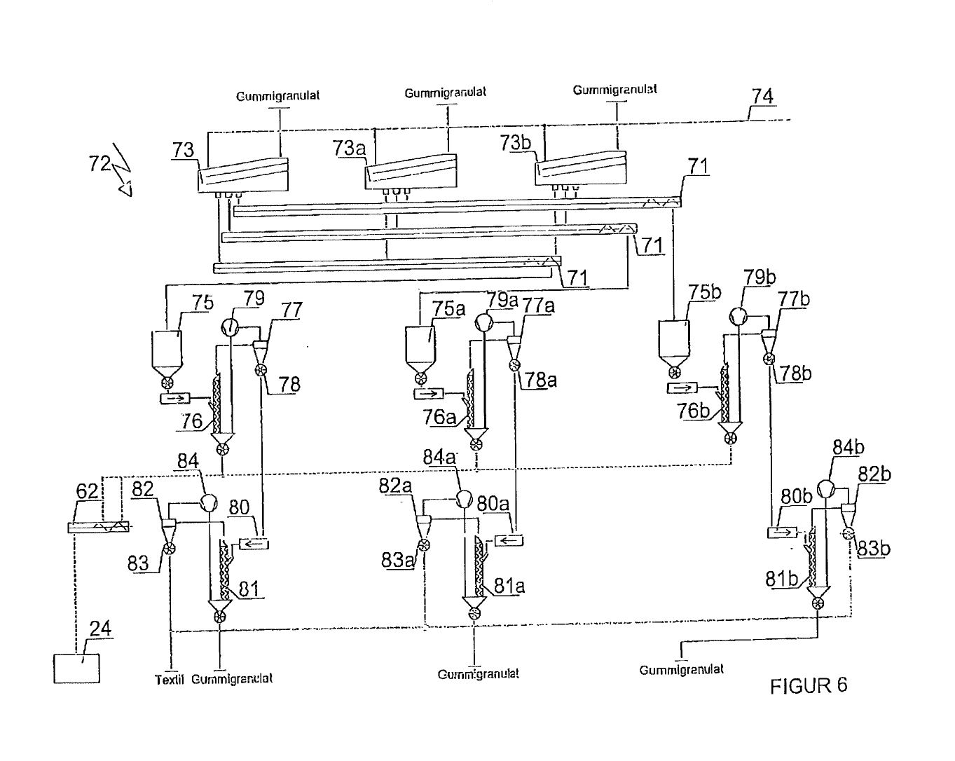

The granulate so pre-cleaned is fed by conveyors 62 to the classifying and cleaning system shown in FIG. 6. Granulate classification is effected in classifiers 73, 73a, 73b—preferably three in number—arranged in parallel.

Classifiers 73, 73a, 73b operate to classify the granulate in—preferably three—different granule size fractions, i.e.granules having different diameters. These classifiers, which preferably are in the form of screening devices, comprise a plurality of superimposed screening decks each equipped with screen cleaning means. The machines are encapsulated in a dust-free manner and connected to central dust aspiration system 74.

Up- and downstream of the classifiers, the conveyors for the various stock streams have sight glasses, filling necks and material flow measuring devices installed thereon, which enable the stock and product flow to be easily monitored at any time, samples to be taken and the operating quality to be monitored. The various granule size fractions are fed to classifying and cleaning system 72.

Mineral and non-magnetic metal contaminants are separated as heavy components through several cleaning stages, while remaining fiber residues are separated in additional cleaning stages as light-weight components.

Metering conveyors 75, 75a, 75b are used to feed the granule size fractions to heavy component separators 76, 76a, 76b specially designed to clean rubber granulates—preferably wind screeners.

In heavy component separators 76, 76a, 76b, the precisely adjusted air stream carries the granules upwards while heavier mineral and metal constituents accumulate in the bottom portion of the unit, are discharged and transported by conveyors to a collection site or to assembly system 24. The granulate is carried by the air stream into separators 77, 77a, 77b, discharged by discharge means 78, 78a, 78b and passed on to the infeeds 80, 80a, 80b of the next following cleaning stage.

The air stream is generated by fans 79, 79a, 79b and is recycled so as to obviate an additional filter-equipped dust removal station.

Infeeds 80, 80a, 80b of the next cleaning stage pass the granulate on to specially designed light-weight component separators 81, 81a, 81b. Light-weight components such as fiber fluff are separated by a precisely adjusted air stream, transported to separators 82, 82a, 82b and discharged via discharge means 83, 83a, 83b. The separated fiber components are passed on to fiber conveyor 69 in assembly system 24. Optoelectronic monitoring and post-sorting means 85, 85a, 85b are provided for separating the last remaining fiber contaminations.

The air stream of light-component separators 81, 81a, 8 1b is generated by fans 84, 84a, 84b and is recycled so that as to obviate additional filter-equipped dust removal stations.

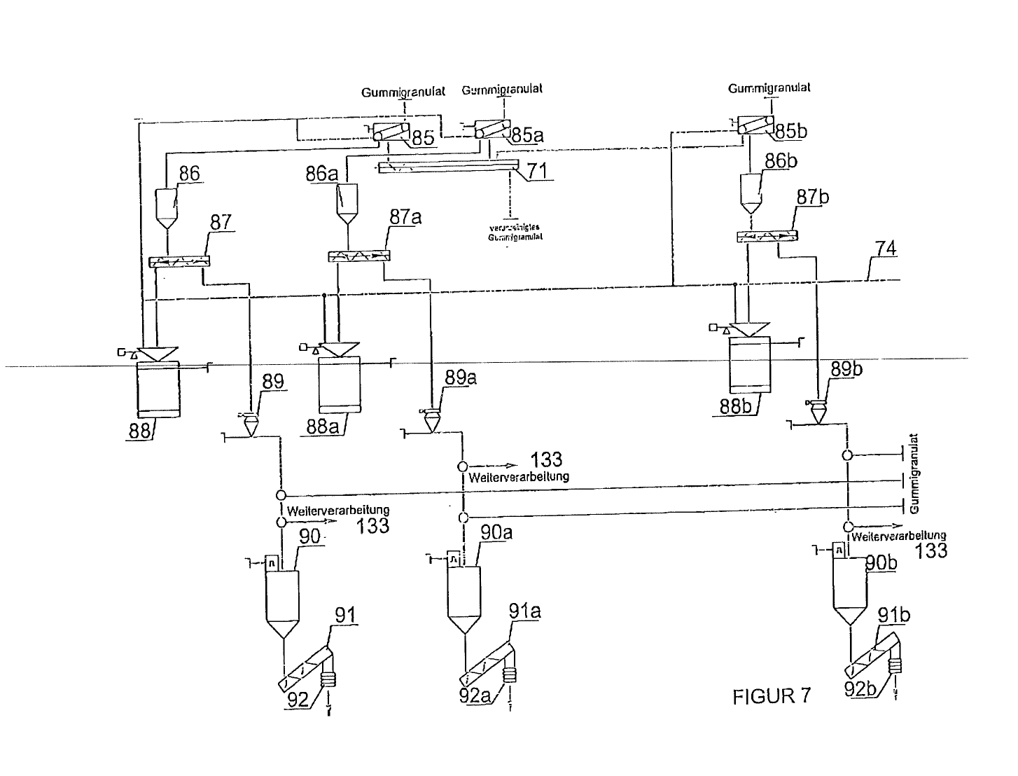

As shown in FIG. 7, the granulate classifying and cleaning system delivers the stock to examining and post-separating apparatus designed to separate rubber particles with adhering fiber matter. The granulate fractions discharged from light-weight component separators 81,81a,81b are directed separately to monitoring and post-sorting means 85, 85a, 85b. Separated as well as misrouted particles are returned to the treatment process.

The granulate fractions so prepared can now be passed on to pulverization 93 orbe packaged as final product and loaded on trucks.

To this end, the granulate fractions are transported from monitoring and post-separating means 85, 85a, 85b to intermediate storage means 86, 86a, 86b from which they are passed on by reversing conveyors 87, 87a, 87b to additional—preferably pneumatic—conveying means 89, 89a, 89b which transport the granulate to pulverizing system 93 or to storage bins 90, 90a, 90b, which preferably are set up outside the building. From storage bins 90, 90a, 90b, the granulate is filled via conveyors 91, 91 a, 9 1b and loaders 92, 92a, 92b into trucks, preferably bulk-type silo trucks.

By changing the direction of movement of reversible conveyors 87, 87a, 87b, the granulate fractions can be moved to packaging means 88, 88a, 88b—preferably big-bag stations—for packaging as uniformly sized high-purity granulates. The granule size and the number of granule size fractions to be packaged can be selected by changing the cut points in classifiers 73, 73a, 73b so as to meet market demands.

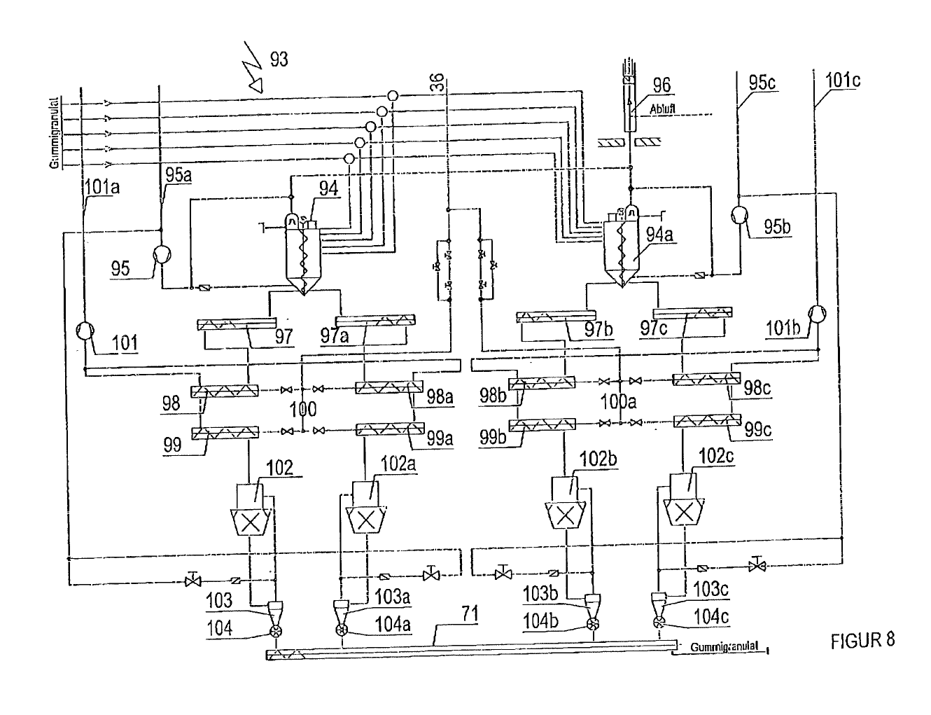

For pulverization, and as shown in FIG. 8, the granulate fractions are transported via conveyors 89, 89a, 89b to pre-freeze units 94, 94a. As required, the plant may include one or several pre-freeze units set up in parallel.

Pre-freeze units 94, 94a, 94b are set up to use the cold used gas from pre-freeze tunnel systems 31 and 31a for cooling the granulate. Cold gas fans 95, 95a are used to supply cold refrigerant gas from freeze systems 31 or 31a. Agitating elements installed in pre-freeze units 94, 94a keep the rubber granules from agglomerating. Having passed the pre-freezing units 94, 94a, the used refrigerant gas is mixed by gas mixer 96 with the exhaust from heaters and driers 49, 106 and then released to the atmosphere.

The pre-frozen granulate is passed on via metering units 97, 97a, 97b, 97d to granulate freezers preferably in the form of screw- or drum-type freezers which, as shown in FIG. 8, consist each of a main freeze system 98,98a,98b and 98c and a temperature equalizing system 99,99a, 99b and 99c; they are connected to a refrigerant supply source 34 and adapted to be controlled to meet existing temperature requirements. Refrigerant supply source 34 is connected by specialized tubing lines 36 and nitrogen supply means 100 or 100a to main freeze system 98-98c and temperature equalizing system 99-99c.

In main freeze and equalizing systems 98-98c; 99-99c, the liquid refrigerant—preferably nitrogen—is sprayed onto the moving granules, whereby the evaporating refrigerant exerts an intensive deep-freeze effect. This results in the granules being deep-frozen down to the required low temperature of approx. −140° C. or lower.

Freeze and equalizing systems 98-98c; 99-99c are provided with independent regulation (closed-loop control) of temperature, conveying speed and nitrogen supply 100/100a. In order to maximize the heat exchange with the refrigerant, the used refrigerant gases are directed in countercurrent fashion across the granulate through the main freeze and equalizing systems 98-98c; 99-99c.

For further utilization of their energy potential, the used refrigerant gases from main freeze systems 98-98c are returned to cold gas inputs 39, 39a of pre-freeze tunnel system 31 and 31a in a cold gas return system comprising cold gas fans 101, 101b and cold gas tubes 101a, 101c. As required, the plant may include one or several granulate freezers set up in parallel.

From equalizing systems 99, 99a, 99b, 99c the deep-frozen brittle rubber granulate is passed on to fine reducers 102, 102a, 102b, 102c, where the rubber granulate is reduced by mechanical means.

In the reduction process, fine reducers 102, 102a, 102b, 102c, which operate at a high speed, generate strong gas currents, which adversely affect the energy consumption. For this reason, the plant includes a cold gas circuit for each one of the fine reducers. Discharged in major amounts, the cold gas carries the powder previously formed into suitable separators 103, 103a, 103b, 103c.

The previously cleaned cold gas is then returned to fine reducers 102, 102a, 102b, 102c. Surplus cold gas is passed on to pre-freeze units 94, 94a. The cold gas return system comprises special tubing and fittings as well as cold gas fans 101, 101b.

If the fine reducers operate at low speeds that do not generate strong air currents, the cold gas circuits may be omitted.

The construction, style, operating parameters and material properties of the fine reducers were developed with the stock properties and the process quantities involved in spent tire recycling in mind and are closely matched to these. The most important characterizing quantity is the fineness and the particle size distribution of the reduction product. The fine reducers 102-102c herein used are designed to produce major percentages of finely particulate product (<100 mm).

Similarly characteristic of cryogenic fine reduction is the structure of each individual particle or grain. For subsequent classification and cleaning, but particularly for most possibilities of further processing the rubber powder, a highly cubic particle form with relatively smooth fracture interfaces and small surface areas is to be considered beneficial. The plant may include one or several fine reducers 102 set up in parallel, as required.

An arrangement comprising several units set up in parallel increases the overall availability of the plant in case any one unit should fail.

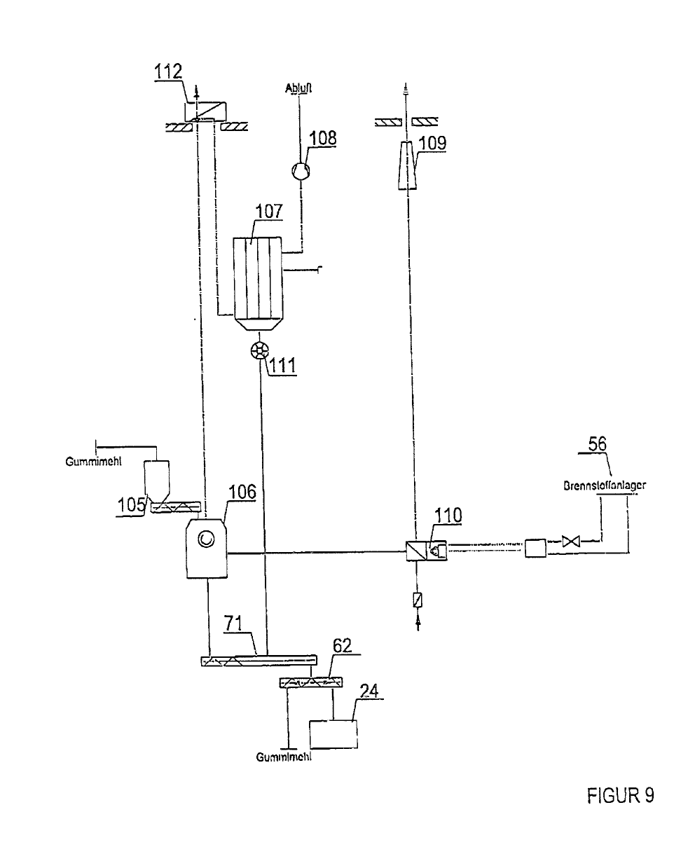

The cold powder so prepared is discharged from separators 103-103c by means of discharge units 104-104c and carried via collecting and conveying system 71 to load means 105 and from there to heating and drying means 106 as shown in FIG. 9.

Because of the very low temperatures, the rubber powder so made will on contact with the ambient air absorb moisture which tends to inhibit subsequent classification and separation. For this reason, a rubber powder heating and drying system 106 is integrated in the plant as shown in FIG. 9. The use of a drum-type drier is preferred as it enables the treatment to be carried out continuously at high throughputs. Special constructional features designed for the treatment of powder—in combination with the rotary movement of the drum—enhance the efficiency of the heat exchange between the drying air and the treated material.

The air is heated indirectly by means of a modulating heater 110 so as to ensure a sparing and safe temperature increase of the material while realizing fire and explosion protection measures in the process. Burner off-gasses are released to the atmosphere through off-gas lines 109.

The exhaust air from the heating process is conducted via tubing lines and suitable safety devices 112 to a dust separator 107 for cleaning.

The dust separator may have a fan 108 associated therewith so as to optimize the air stream. The dust separator 107 includes all necessary safety devices for, and is designed to meet, the stringent requirements of fire and explosion protection.

Via discharge means 111, collecting and conveying means 71 and conveyors 62, the extracted dust is passed on to a suitable assembly system 24 or returned into the main product stream.

It is contemplated to use alternative heating and dryingmeans based on other principles, such as heated surfaces directly contacting the material to be dried. The heating and drying system has a fuel supply system 56—preferably oil or gas—associated therewith.

The powders so fabricated are finely particulate and tend to agglomerate, inhibiting the classification of fines. Such agglomeration may be prevented by adding metered amounts of a dispersing agent. For this reason, the main product stream is supplied to a mixer 114 for mixing prior to classification with metered amounts of dispersant from metering means 115.

The output of mixer 114 is transported by conveyor 116 to separator 117 where steel residues liberated in the pulverization process and ultrafine abraded steel particles are removed from the rubber powder by high-performance high-penetration magnets. The rubber powder so prepared is transported to intermediate storage 118 by conveyors 62.

The powder classifying means—preferably multiple-deck screeners 120, 120a—are characterized by a plurality of possible separation cuts, a high separation sharpness in the fine and ultrafine ranges, a compact construction and a service-friendly design.

Screen cleaning systems are provided to reliably keep the screen mesh open and unclogged. The machine design is such as to keep the dynamic forces transmitted to the set-up location as low as possible. To meet market requirements, the size and the number of the rubber powder grain fractions is freely selectable by changing the separation cuts in powder classifiers 120, 120a.

The various grain fractions are passed on separately to cleaning processes by collecting and conveying means 71. Owing to the fineness of the powder, the cleaning processes should be matched precisely to the grain size of each grain fraction. Coarser grades are passed on from selecting and conveying means 71 to additional fiber separators 121 a, 12 1b, which are followed by light-weight particle separators 122a, 122b.

Separated fiber fluff is transported pneumatically to dust separators 123, 123a, 123b and to assembly system 24. The necessary air stream is generated by a fan 124, 124a, 124b. From light-weight component separators 122a, 122b, the coarser rubber powder is transported grain fraction-wise to intermediate storage 126, 126a, 126b. From intermediate storage 126, 126a and 126b, the powder fractions are carried by reversible conveyors 127, 127a, 127b to additional pneumatic conveyors 129, 129a, 129b which transport the power into bins 130a, 130b or to further processing in plants 131.

By changing the direction of transport of reversible screw conveyors 127a, 127b, the power fractions can be provided to packaging means 128a and 128b—preferably big-bag stations—for packaging as a uniformly sized high-purity rubber powder.

Ultrafine powders are passed on from collecting and conveying means 71 to powder cleaners 125, 125a, where any remaining fiber residues are separated and discharged by dust aspirator 74.

From powder cleaners 125 and 125a, the finely particulate rubber powder is transported grain fraction-wise to intermediate storage bins 126c and 126d. From intermediate storage bins 126c and 126d, the powder fractions are passed on by reversible conveying means 127c, 127d to additional—preferably pneumatic—conveyors 129, 129a, which direct the powder into storage bins 130c, and 130d or to further processing plants 133.

The storage bins are set up preferably outside the building. From bins 130a-130d, the product is directed by conveying means 131-131d to loaders 132-132d for loading into transport vehicles such as tank trucks.

By changing the direction of movement of reversible screw conveyors 127c and 127d, the powder fractions can be directed to packaging means 128c and 128d, which preferably are big-bag stations. In addition to the main product stream, a secondary stream is established in the powder classifying and cleaning section for cleaning the fine material separated in pre-classifying system 60. The finely particulate material is passed from separators 66, 66a, 66b and the collecting and conveying means to another fiber separator 121, which is followed by a light particle separator 122.

Separated fiber fluff is transported pneumatically into dust separator 123 and from there to assembly system 24. A fan 124 is provided for generating the required air stream. From light particle separator 122, the fine material is passed on to a steel separator 117. Via intermediate storage 126, the fine material so processed is directed to reversible conveyor 127 and selectively to pulverization system 93. As a final product, it may be transported to packager 128—preferably a big-bag station—or by means of pneumatic conveyor 129 or 131 to storage bin assembly 130 or to a loader 132.

The rubber powder so classified and cleaned is suited for further processing into final products and constitutes a substitute for a wide variety of rubber raw materials.

Thus, there has been disclosed a system capable of recycling scrap rubber and rubber waste products. This invention can recycle rubber scrap and rubber waste products for use as raw materials for other production processes. This invention allows for a more complete recycling than previously known in the art. It can produce rubber granulates and rubber powder of a very high purity, which can then be easily incorporated into new rubber products.

Whereas the present invention has been described with respect to specific embodiments thereof, it will be understood that various changes and modifications will be suggested to one of ordinary skill in the art, and it is intended that the invention encompass such changes and modifications as fall within the scope of the appended claims.

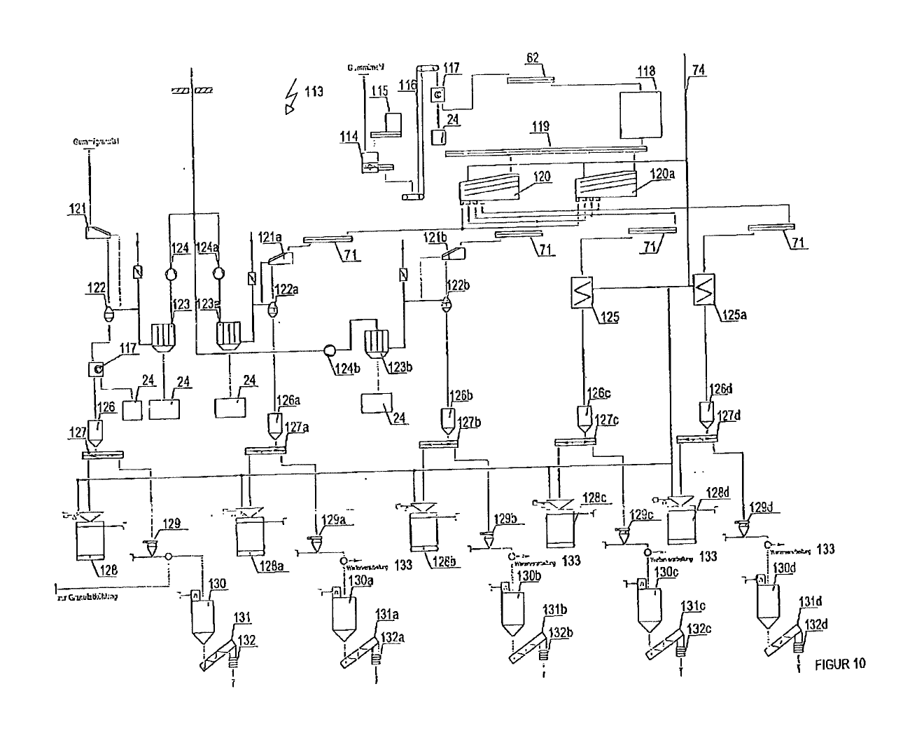

Text in FIGs

| | |
|---|---|
| FIG. 1 | |
| Fremdstoffe | Foreign materials |
| Reifenstücke | Tire chunks |
| FIG. 2 | |
| Reifenstücke | Tire chunks |
| FIG. 3 | |
| Reifenstücke | Tire chunks |
| Gummigranulat | Rubber granulate |
| FIG. 4 | |
| Abluft | Exhaust air |
| Gummigranulat | Rubber granulate |
| Brennstoffanlage | Fuel supply system |
| FIG. 5 | |
| Verunreinigtes | Contamianted rubber granulate |
| Gummigranulat | |
| Gummigranulat | Rubber granulate |
| Textil | Fiber |
| Ballenpresse | Baling press |
| FIG. 6 | |
| Gummigranulat | Rubber granulate |
| Textil | Fiber |
| FIG. 7 | |
| Verunreinigtes | Contaminated rubber granulate |
| Gummigranulat | |
| Gummigranulat | Rubber granulate |
| Weiterverarbeitung | Further processing |
| FIG. 8 | |
| Abluft | Exhaust air |
| Gummigranulat | Rubber granulate |
| FIG. 9 | |
| Abluft | Exhaust air |
| Gummimehl | Rubber powder |
| Brennstofflager | Fuel supply system |
| FIG. 10 | |
| Gummigranulat | Rubber granulate |
| Gummimehl | Rubber powder |
| zur Granulatkühlung | To granulate cooling system |
| Weiterverarbeitung | Further processing |

What is claimed is:

1. A system for processing material comprising:
a multi-stage pre-reduction system;
a multi-stage freeze system;
a freezing means for freezing a product to its brittle temperature; and
at least one fine reducer that further reduce the material connected in parallel
wherein a material to be processed enters the multi-stage pre-reduction system, then is transported to the multi-stage freeze system, then is transported to the freezing means then is transported to said at least one fine reducer.

2. The system of claim 1 wherein the multi-stage freeze system comprises:
a pre-freeze tunnel system that can be injected with cold used refrigerant gas;
a main freeze tunnel system in which a low-temperature liquid refrigerant may be sprayed onto the material; and
a temperature equalizing system used to equalize the temperature of the material wherein the pre-freeze tunnel and the main freeze tunnel are horizontally parallel and the temperature equalizing system is located between the pre-freeze tunnel and the main freeze tunnel.

3. The system of claim 2 wherein the freezing means comprises:
a second pre-freeze tunnel system set up to use the cold used gas from the pre-freeze tunnel system to cool the material;
a second main freeze tunnel system in which a low-temperature liquid refrigerant may be sprayed onto the material; and
a second temperature equalizing system used to equalize the temperature of the material wherein the second pre-freeze and the second main freeze tunnel are horizontally parallel and the second temperature equalizing system is between the second pre-freeze tunnel and the second main freeze tunnel.

4. The system of claim 3 further comprising a plurality of freezing means connected in parallel.

5. The system of claim 4 wherein the pre-freeze tunnel system can have a low-temperature refrigerant gas removed and further can use a low-temperature refrigerant gas from any other multi-stage freeze system.

6. The system of claim 4 wherein the fine reducers are connected with metal separators connected and the metal separators are connected with cryogenic separators for the release of rubber fragments, as well as additional reducers.

7. The system of claim 4 wherein the fine reducers are connected with heating and drying means where said heating and drying means are connected in parallel with a pre-classifying system that produces material and one or more post-processing devices.

8. The system of claim 7 wherein output from the post-processing devices is merged with the material separated in pre-classifying system and is sent to separators.

9. The system of claim 8 wherein the separators are connected to multi-stage classifying means.

10. The system of claim 9 wherein the classifying means are connected with heavy-grain separators and light-grain separators.

11. The system of claim 1 further comprising an optoelectronic monitoring and post-sorting means.

12. The system of claim 4 wherein the low-temperature refrigerant gas may be directed by cold gas fans and cold gas tubing lines from the multi-stage freeze system into the freezing means.

13. The system of claim 4 wherein the pre-freeze tunnel system, the second pre-freeze tunnel system and the heating and drying means are connected with gas mixers for merging the used refrigerant gas and drying gases.

14. The system of claim 13 further comprising a granulate freeze system connected with the fine reducers and a circuit system of directing the used refrigerant gas serving.

15. The system of claim 13 wherein the granulate freeze system and the low-temperature fine reducers connected with cold gas fans and cold gas transport means for carrying used refrigerant gas to the pre-freeze tunnel system.

16. The system of claim 15 wherein the low-temperature fine reducers are connect with the heating and drying means, a mixer, and a metering means for the addition of a dispersing agent.

17. The system of claim 15 wherein the mixer is connected with a powder classifying system, a light-material post-separating means subdivided according to powder grain sizes and a powder cleaning means.

18. A system for the treatment of material comprising:
a pre-reduction system;
a freeze system divided into a plurality of freeze zones which may spray a low-temperature refrigerant onto the material;
a temperature equalizing system; and
a multi-stage fine reducers for the stepwise reduction of the material wherein the material is processed from the pre-reduction system to the freeze system to the temperature equalizing system to the multi-stage fine reducers.
